(19) United States
(12) Patent Application Publication
(10) Pub. No.: US 2008/0135406 A1
(43) Pub. Date: Jun. 12, 2008

(54) Gas Sensor

(75) Inventors: Stephen Skinner, Hampshire (GB); Edwin Raj, London (GB); John Kilner, Surrey (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(73) Assignee: IMPERIAL COLLEGE INNOVATIONS LTD., London (GB)

(21) Appl. No.: 11/572,422

(22) PCT Filed: Jul. 21, 2005
(86) PCT No.: PCT/GB2005/002868

§ 371 Date: Oct. 25, 2007

(30) Foreign Application Priority Data
Jul. 21, 2004 (GB) 0416311.9

(51) Int. Cl. G01N 27/26

(52) U.S. Cl. 204/400

(57) ABSTRACT

A gas sensor which comprises an Aₙ₊₁BₙO_{(3n+1)±}_{^{δ}} type material in which A is an alkaline earth metal or lanthanide and B is a transition element or a group 13 element, and O is oxygen, n is an integer greater than or equal to 1, and 0≦δ≦0.2.

The present invention is directed towards gas sensors, and in particular to gas sensors which are able to accurately detect the presence of low levels of gases at high temperatures.

Gas sensors have developed in parallel with the industrialization of society where various chemicals and fuels have become an essential part of domestic and industrial life. There are a significant number of gases which are emitted into the atmosphere during the preparation or use of the chemicals or fuels which are potentially hazardous if consumed in relatively small quantities by humans and animals.

Carbon monoxide, a principal atmospheric pollutant, is a toxic gas emitted into the atmosphere as a result of combustion processes. CO poses a serious health hazard by preventing the normal transport of oxygen by the blood leading to a significant reduction in the supply of oxygen to the heart. The lower exposure limit (LEL) of CO in air is stated in the international regulations for environmental pollution to be 35-50 ppm. However, CO concentrations can often reach levels that are some factors of tens higher than the LEL. Extensive research has been carried out in identifying suitable materials for moderate temperature sensing of CO and some commercially successful sensors have been developed. Unfortunately there has been little success with their high temperature counterparts, though a sizeable quantity of CO is produced in the harsh industrial environments found in the steel, heat treating, metal casting, glass, pulp and paper, automotive, aerospace and power industries.

Ammonia is an increasing problem since it took the place of CFCs in many applications, in particular in refrigeration. Ammonia may cause irritation of the mucous membrane at levels of a few hundred ppm and respiratory problems at 1000 ppm. It may be fatal at levels of 2000 ppm. In the UK and USA the Tone Weighted Average (TWA) for ammonia is 25 ppm over 8 hours and the short-term exposure (STE) is 35 ppm for 15 minutes.

Other gases which may require accurate detection include, but are not limited to the following: nitrogen oxides, alcohol, hydrogen sulphide, sulphur dioxide, unburned hydrocarbons, hydrogen and carbon dioxide.

A range of methods and materials for the detection of gases which result from domestic or industrial processes have been developed. These include infrared detectors, semiconductors, thermal conductivity sensors, electrochemical sensors, paramagnetic sensors, solid electrolytes and micro-optical electrochemical systems, and surface acoustic wave systems. In particular, sensors known as resistive type gas sensors based on ceramic oxides are effective due to the relatively simple instrumentation and the high physical and chemical stabilities of the oxides. Tin oxides, which may or may not be doped (for example with platinum), are particularly preferred although similar materials using polymers and copper oxides or chromium titanium oxides (CTO) are also used. Other materials which have been considered include perovskites, heterojunctions and organometallics.

The use of a range of materials for CO sensing in resistive type sensors has been discussed in the literature. Perovskites such as LaMnO₃ and BaSnO₃; doped and undoped SnO₂ and ZnO; AlN/AlGaN-heterostructures, mixed potential junctions such as CuO-ZnO, molybdates and Nafion® (an ionomer membrane) films have been discussed. These sensors exhibit a number of common problems. Firstly there is the stability factor, which restricts the use of the majority of these oxide based sensors at temperatures above 450° C. A number of CO sensors are available on the market for intermediate temperature sensing (maximum 450° C.) but there are few available for harsh industrial conditions (typical operating temperature >450° C.), which account for nearly one third of CO emission. There is therefore a need for a sensor which can detect gases, in particular CO, at high temperatures.

Secondly, there are problems with the sensitivity of the prior art sensors. Most prior art sensors only detect down to a level of, for example, 50 ppm CO and with ever more stringent guidelines being implemented, this level of detection may not be sufficient. For example, as mentioned above, the LEL for CO is 35-50 ppm. There is therefore a need to accurately detect CO and other reducing gases at low levels which are still significant enough to cause health problems to anyone who inhales them.

Thirdly, there are problems with the selectivity of the prior art sensors for the gas or gases which are to be detected. This is a particular problem in the presence of water vapour and higher relative humidity which can result in sensors giving false readings and/or affecting the sensitivity of the sensor for the chosen gas. There is therefore a need for a sensor with improved selectivity, in particular in the presence of water vapour.

Other problems with prior art sensors include the response and recovery time of the sensors which could also be improved as it is important to know as soon as possible what the level of a particular gas is in an environment and also when the area becomes safe again. Prior art sensors also suffer from problems of ageing (how the performance of the sensor changes with the age of the sensor) and drift (the ability of the sensor to return fully to the starting composition after each use). The prior art materials also often require dopants to become effective and this is expensive both because of the additional material and the increased complexity in manufacture.

A further problem with prior art sensors is that in many cases the conductivity of the sensor is relatively low and it is therefore necessary to have multiple layers of material to form a sensor which can detect and measure a signal reliably. This results in sensors which are difficult to prepare and hence expensive to manufacture as it is necessary to control the manufacturing so that the conditions are exactly the same on the application of each layer.

There is therefore a need for an alternative gas sensor which overcomes these problems with the prior art.

According to the present invention there is provided a gas sensor which comprises an Aₙ₊₁BₙO_{(3n+1)±}_{^{δ}} type material in which A is an alkaline earth metal or lanthanide and B is a transition element or a group 13 element and O is oxygen, n is an integer greater than or equal to 1 and 0≦δ≦0.2. These Aₙ₊₁BₙO_{(3n+1)±δ} materials are layered perovskites and they can accommodate excess oxygen in their interstices and it is thought that this provides selective adsorption sites for any reducing gases, for example CO, NH₃ and NO₂. In a particular embodiment of the invention, n=1 and the material is A₂BO_{4±δ}.

Sensors according to the present invention are sensitive to a wide variety of gases, and are adjustable to detect different gases by means of variations in temperature (they may be effective over a range as broad as room temperature and 800° C.) and by using appropriate substitutions on either or both of the A and B sites. They are also largely unaffected by the presence or not of water vapour and to be rapid in responding to changes in the environmental levels of the gas being tested. The sensors have also been found to be sensitive to particularly low levels of many gases, for example 1 ppm CO. They also have substantially higher conductivities than the prior art sensors and therefore it is not necessary to have multiple layers to get a detectable and measurable signal.

The detection of CO and other reducing gases involves the “surface layer controlled gas sensing” mechanism, which requires a depth of only a few nanometers from the sensor material due to gas-solid interactions that change the charge density in the oxide or at the intergranular boundary, depending on whether the layer is continuous or forms any potential (Schottky) barrier across the intergranular boundary. Some prior art oxide based CO sensors exploit Schottky barriers wherein oxygen adsorption from the ambient air on to the exposed sensor surface takes place, extracting an electron from the material resulting in O⁻ or O²⁻ (mainly O⁻). Combustible gases, such as CO react with the adsorbed oxygen thereby increasing conductivity, and form the basis of sensor response. Nevertheless, a material that is rich in oxygen can exert preferential adsorption of gases such as CO effecting an immediate variation in space charge density on the oxide surface which is reflected in the magnitude of conductivity.

In the present invention, the applicants have found that the Aₙ₊₁BₙO_{(3n+1)±δ} compounds are thermally stable (mp. >1500° C.) and exhibit a wide variety of oxygen stoichiometries including accommodating excess oxygen (for example, A₂BO_{4±δ}) via interstitials rather than by the usual cation vacancies. These materials have considerable oxide ion mobility even at relatively low temperatures and significantly contain highly mobile oxygen interstitials. Atomic scale computer simulation based on energy minimization techniques to study the excess oxygen accommodation and migration indicates that oxygen mobility is anisotropic involving an interstitially mechanism. The properties such as conductivity can be tuned by substitution on either or both ‘A’ and ‘B’ sites enabling a range of materials with purely ionic through mixed ionic-electronic to purely electronic conduction, to be produced.

These oxygen excess compounds may therefore be used in the sensing of combustible (reducing) gases such as carbon monoxide (CO). High temperature X-ray and thermogravimetric studies on oxygen excess A₂BO_{4±δ} phases also revealed that the excess oxygen is normally intact up to 750° C. which enables them to be used as high temperature gas sensors. These materials are also advantageous from the point of view that with suitable substitution on ‘A’ and/or ‘B’ sites, the surface charge density can be varied which may help to induce selectivity towards carbon monoxide (or another selected gas) in a mixture of competing gases without the use of any external dopant (often platinum is used).

The sensor may additionally include one or more substituents replacing some of either the A or B material. The substituent may be one or more selected from the list comprising strontium, magnesium and aluminium. The substituent(s) is (are) chosen to be synergistically compatible with the A and B site elements in the material. In particular, they must be compatible stoichiometrically and also provide the necessary conductivity.

The oxide materials are made using any of the known physical and chemical deposition methods such as one of the various synthetic routes available including conventional solid-state synthesis, sol-gel (polymeric gel combustion, glycine-nitrate) and combustion synthesis based on propellant chemistry which gives very large surface areas. The sensing behavior of the oxide may be influenced by the process conditions and therefore the different processing routes will provide sensor materials of different properties.

In the formation of sensors according to the present invention, these oxide materials may be screen-printed or coated as a thin layer (by applying a suspension of the sieved oxide in n-heptanol) on to a sensor array. The ink is allowed to dry and conductors may be spot welded onto the sensor assembly. The sensor array may be an alumina substrate or any other electrically insulating ceramic material. The conductors may be interdigitated platinum/gold electrodes, silver electrodes or electrodes made of any other electrically conducting metal. The drying step may be carried out at high temperature, for example greater than 800° C., in particular around 1000° C. and may be carried out under ambient conditions.

The sensors of the present invention may be optimised for a particular environmental situation by varying the composition of the Aₙ₊₁BₙO_{(3n+1)±δ} material, the method of production of this material, the concentration of this material on the sensor substrate and the positioning of the conductors on the sensors. The properties of the sensor may also be controlled by varying the substrate material, electrode configuration, electrode material, the deposition method, or the particle size or morphology or the porosity of the sensor, or any combination of the above parameters. The resulting sensors may have different reactions to humidity, the operating temperature, the concentration range of the gas being sensed, the duration of the gas discharge.

The invention may be put into practice in a number of ways and various embodiments will be described below by way of example with reference to the following figures, in which:

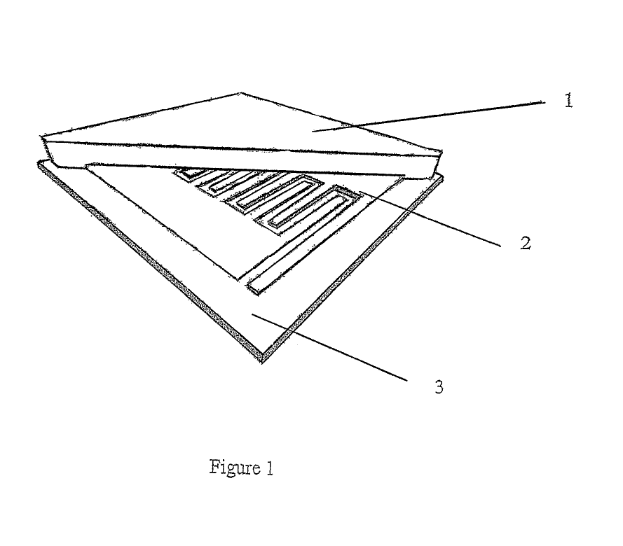

FIG. 1 shows a schematic embodiment of the sensor array design;

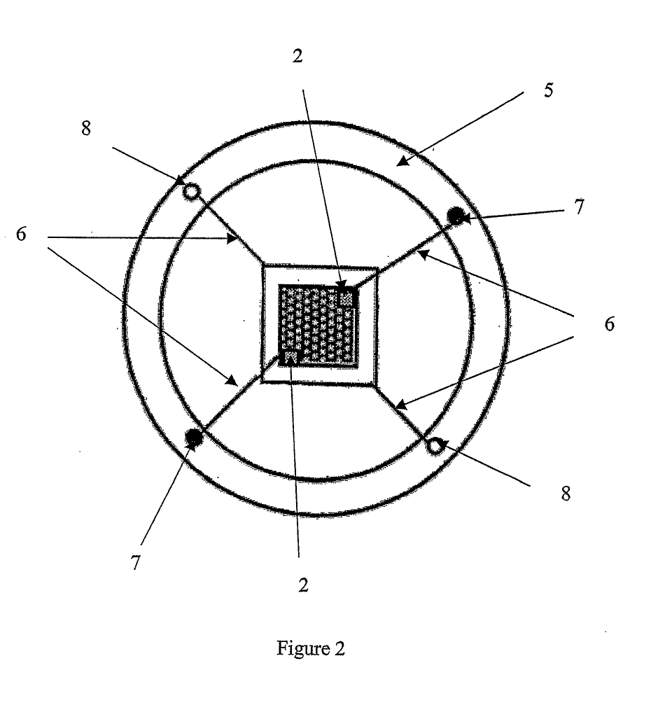

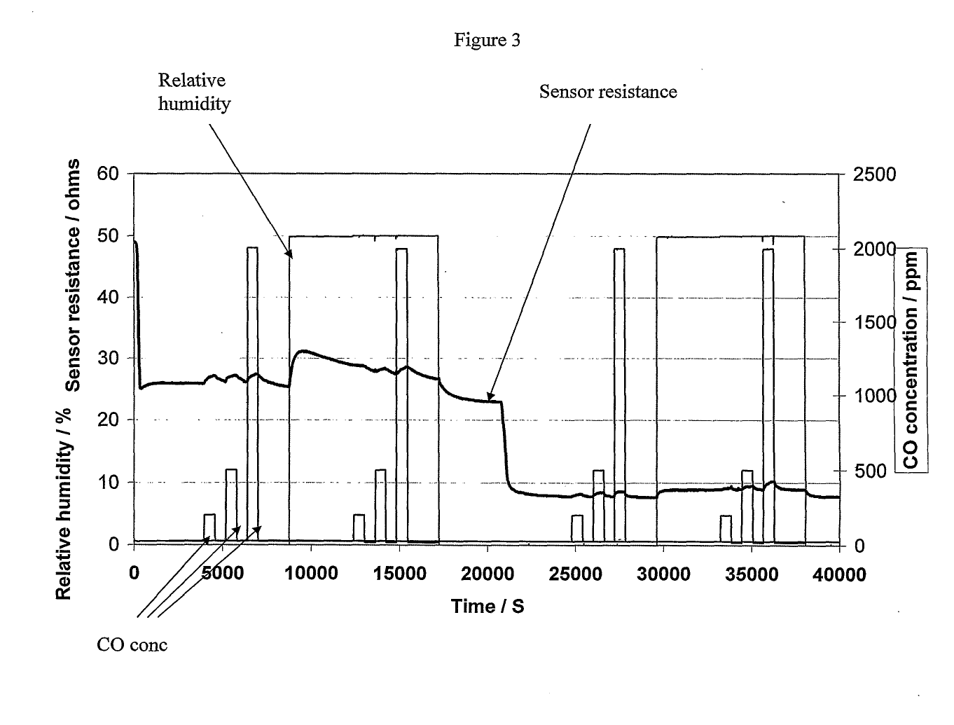

FIG. 2 shows a schematic plan view from above of an embodiment of the sensor; FIGS. 3 to 7 and 9 show the variation in resistivity of a number of sensors according to the present invention with different gases at different concentrations and varying temperature and relative humidity;

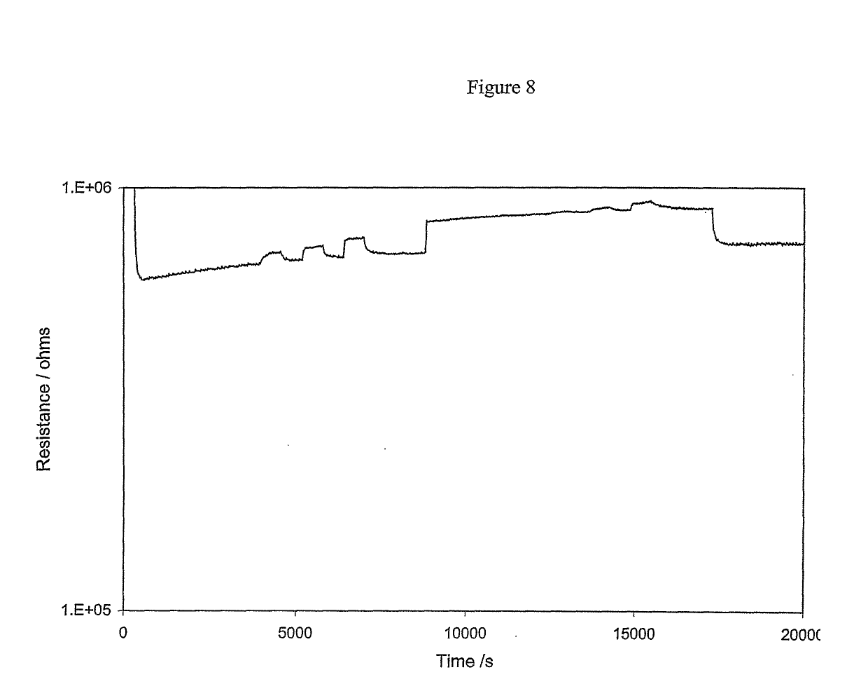

FIG. 8 shows variations in resistivity for a prior art sensor in response to change in gas concentration and relative humidity; and

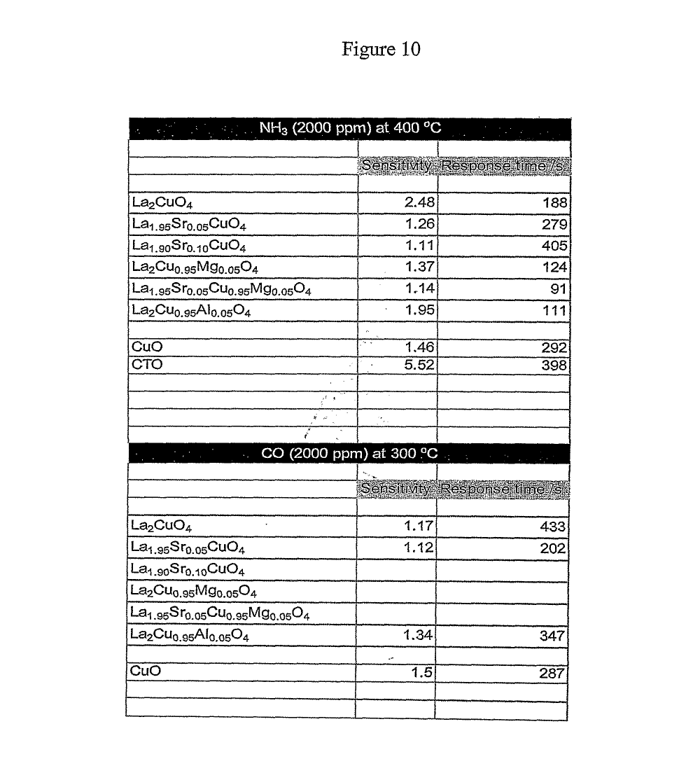

FIG. 10 is a table giving sensitivity and response time data for a number of sensors, some according to the present invention and some prior art sensors.

A range of A₂BO_{4±δ} materials were tested for different gases (CO, NH₃ and NO₂) and the effect of gas concentration, humidity and temperature on the performance of the sensor was observed. In each case, the sensors were prepared in a similar way using the different oxide powders as set out below and using appropriate conditions to remove solvents where indicated.

FIG. 1 shows an embodiment of the sensor array design according to the present invention. The figure is partially cut away in order to provide a clearer view of the design. The sample material 1 comprises the pre-processed oxide powders mixed with appropriate amounts of organic vehicle and made into an ink in a roll-mill. The oxide powders were prepared by the solid state ceramic route and subsequently processed (ball milled and sieved) to form a layered perovskite material with a particle size between 1 and 10 μm. In the cases where the oxide had one or more substituent, this was introduced as appropriate in the reaction process. The ink is then screen printed onto a sensor array comprising a gold electrode 2 which is shown as an interlocking pattern on an alumina substrate base 3. The array is then fired at a temperature sufficient to remove the organic vehicle, for example about 700° C. for about 2 hours, leaving the oxide sample as a layer on the top of the sensor array. A platinum microheater (not shown) is present underneath the alumina substrate. The sensor array is small and is approximately 2 mm×2 mm.

As shown in FIG. 2, the sensor array is placed within a sensor assembly 5. The array is secured to the assembly using platinum connectors 6 which spot weld the array to the assembly. Also present in the sensor assembly are electrode leads 7 which are connected by the platinum connectors 6 to the gold electrodes 2. There are also heater leads 8 which are connected to the microheater by means of the platinum connectors 6.

The sensitivity of different sensor materials to various gases under different conditions was tested. In particular the temperature was varied from 150-500° C. and the humidity was varied from 0 to 50% relative humidity. The concentration of the gas to be tested was also varied as discussed below. In most cases the test gas was switched on and off at ten minute intervals.

FIG. 3 shows the variation in resistivity in a La_{1.95}Sr_{0.05}CuO₄ sensor for a varying gas concentration of CO at two temperatures and in the presence and absence of humidity. The temperature for the first 20000 seconds was maintained at 150° C. and initially there was 0% humidity. Different concentrations of CO were supplied to the system for ten-minute periods as shown by the curve in FIG. 3. Firstly 200 ppm, then 500 ppm and finally 2000 ppm were applied. In each case, the response of the sensor was measured and the curve indicates a response for each time CO was supplied to the system.

The relative humidity was then increased to 50% and the sensor responded to the change in the atmosphere with an increase in resistance. After allowing time for the sensor to settle, further pulses of CO gas were introduced at the same concentrations as previously and again the sensor reacted to the addition of the CO. At around 20000 seconds, the temperature of the system was increased to 300° C. and the resistance of the sensor dropped significantly and hence the conductivity increased. As before different concentrations of CO were supplied to the system (200, 500 and 2000 ppm) as shown by the curve in FIG. 3 at both 0% and 50% relative humidity. Again, the response of the sensor was measured and measurable response can be seen even for the addition of 200 ppm CO at 50% relative humidity.

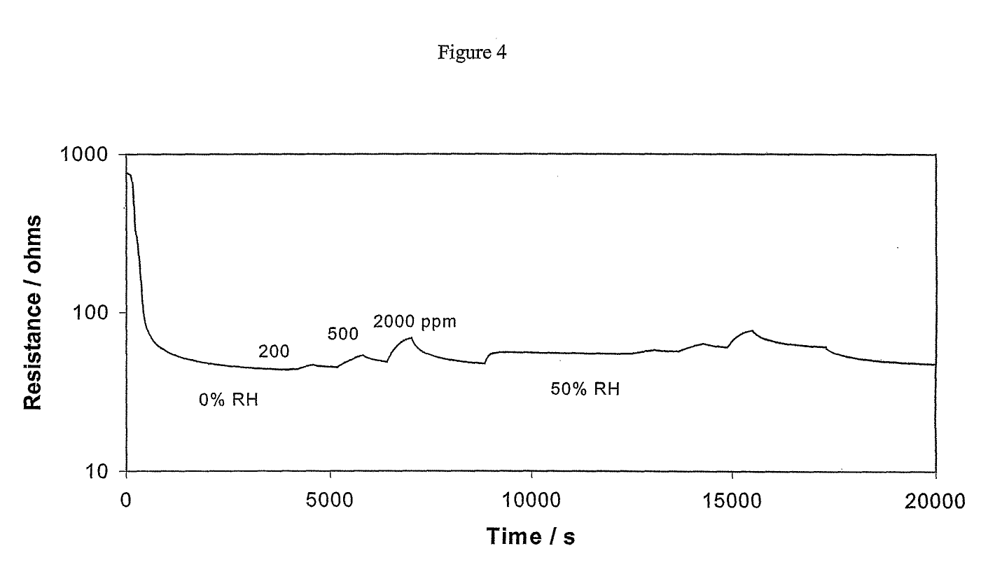

FIG. 4 shows the effect of increasing gas concentration (from 200 to 500 to 2000 ppm of CO) on the same sensor as that for FIG. 3 at 0% (left hand side (LHS)) and 50% (right hand side (RHS)) humidity and at a fixed temperature of 300° C. In both cases there are detectable changes in resistance as the CO concentration is applied although the effect is stronger at 0% relative humidity than at 50%.

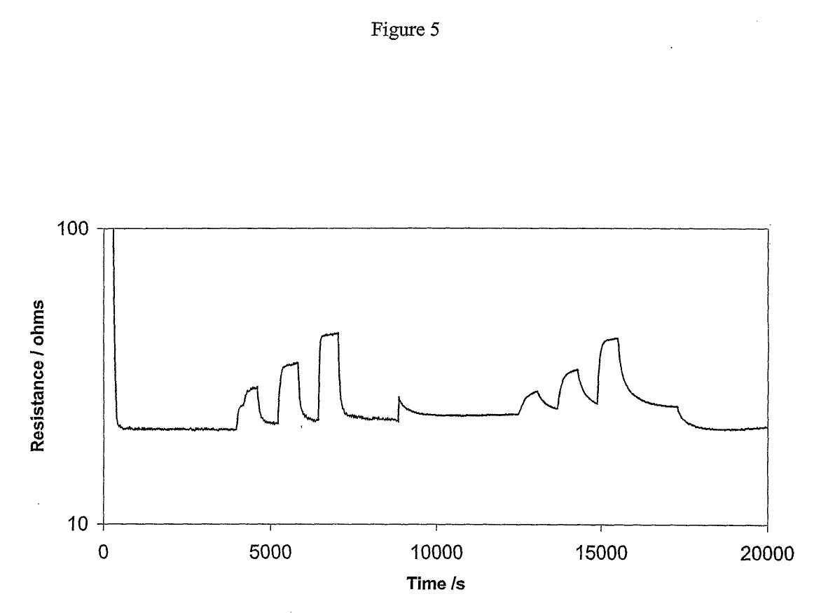

FIG. 5 shows the effect on the same sensor as for FIGS. 3 and 4 of varying the concentration of NH₃ (from 200 to 500 to 2000 ppm) at 0% (LHS) and 50% (RHS) humidity and at a fixed temperature of 400° C. and again there are clearly detectable changes in resistance when the NH₃ is present (even at the lowest level) and when it is removed again. The effect is equally detectable at 50% relative humidity as at 0%.

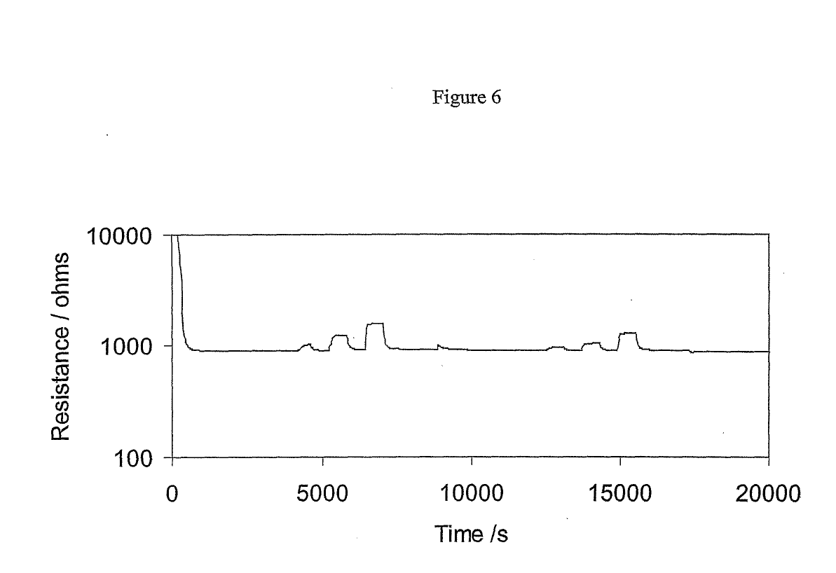

FIG. 6 shows the effect on a second sensor of varying the concentration of NH₃ (from 200 to 500 to 2000 ppm) at a fixed temperature of 500° C. and at both 0% (LHS) and 50% (RHS) relative humidity. This is for a sensor La₂CuO₄ which has no substitutions on either the A or the B site. The significant result which is demonstrated in this graph is that there is no change in the resistance measured at 0% and 50% relative humidity. In this case, you can calibrate your sensor with the resistance values for a specific temperature (in the absence of NH₃) and any variation from this can therefore be directly attributed to the presence of some NH₃. This forms a crude sensor for the presence or absence of a selected gas.

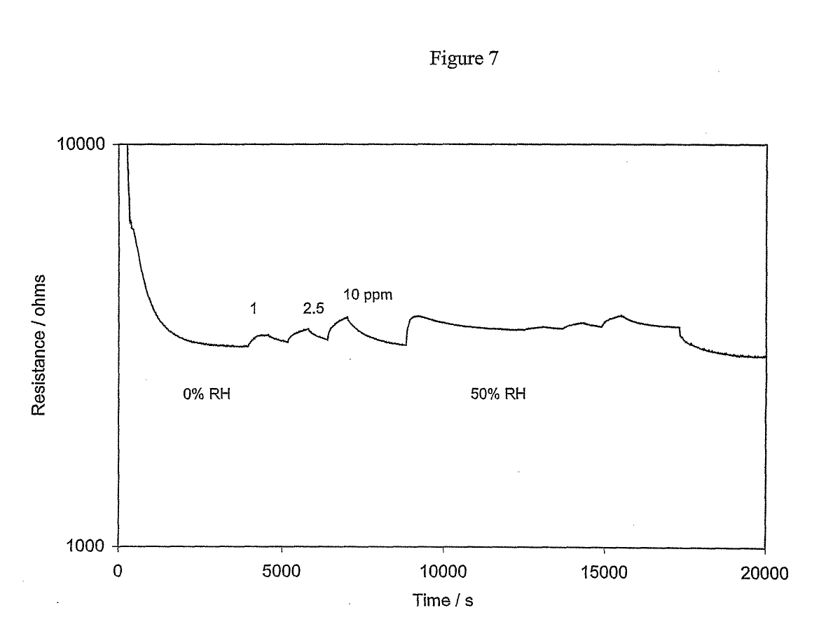

FIG. 7 shows the effect of very low concentrations (1, 2.5 and 10 ppm) of NH₃ on the resistivity of the La₂CuO₄ sensor at 400° C. at both 0% (LHS) and 50% (RHS) relative humidity. While the presence of 1 ppm NH₃ can be detected at 0% relative humidity, the effect is harder to detect at 50% relative humidity. However, 10 ppm does provide a significant variation in the resistance even at 50% relative humidity. The sensor is therefore able to operate at high relative humidity and is still able to detect a low concentration of the NH₃.

FIG. 8 shows the effect of relative humidity on a prior art sensor based on copper oxide (CuO). There is a significant change in resistance with an increase in relative humidity from 0% (LHS) to 50% (RHS).

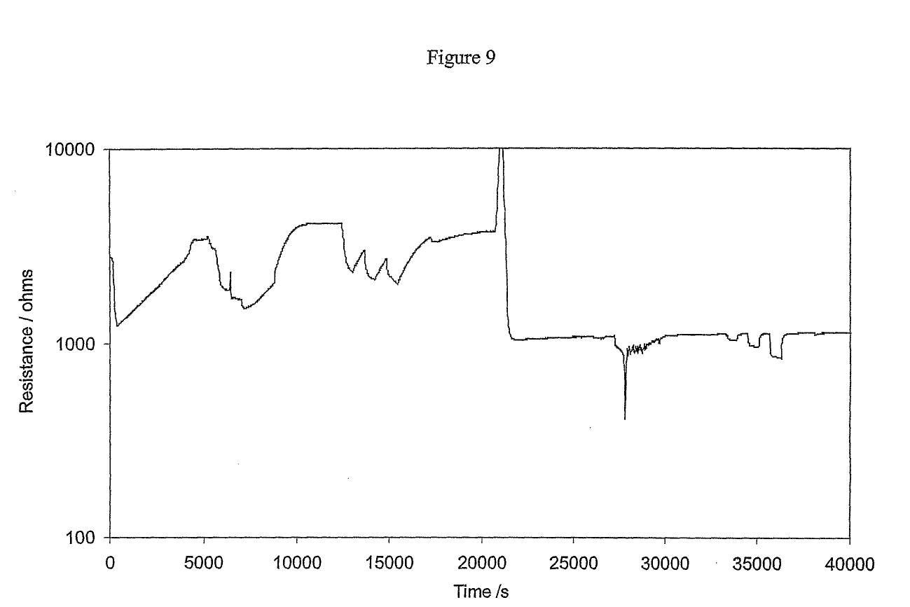

FIG. 9 shows the effect of varying concentrations of NO₂ on a sensor according to the present invention of La₂CuO_{4+δ} at two different temperatures (400 and 600° C.) and at 0% (LHS) and 50% (RHS) relative humidity. In this case there is better resolution of the signal in the presence of water.

FIG. 10 shows the sensitivity and response time of a number of embodiments of the present invention together with two examples of prior art systems (CTO and CuO). The sensitivity for a particular gas is the ratio of the resistivity in the gas to the resistivity in air. The response time is the time taken to get 90% of the signal response to a change in the environment of the sensor. The sensors of the present invention exhibit similar sensitivities for NH₃ and CO to the prior art sensors but better response times.

A further advantage of the sensors of the present invention over the prior art is that the resistivity is orders of magnitude lower than those of the prior art systems and hence the conductivity is higher. The conductivity of the sensors of the present invention may be of the order of 1×10⁻⁴ to 1×10⁻² S m⁻¹ compared with 1×10⁻⁶ S m⁻¹ for prior art sensors. The sensors of the present application can therefore be used for miniature and small area applications, as it is not necessary to have multiple layers of the material to get a signal. This means that the sensors are easier and cheaper to manufacture as for multiple layer applications it is necessary to have exactly the same conditions for each application of a new layer. The sensors of the present invention are therefore more reliable in manufacture than those of the prior art because of the relative ease of manufacture. If it is necessary to increase the resistance (and hence decrease the conductivity) of the sensors of the present application, this can be achieved by increasing the gap between the electrodes.

1. A gas sensor which comprises:
an Aₙ₊₁BₙO_{(3n+1)±δ} type material in which A is an alkaline earth metal or lanthanide, B is a transition element or a group 13 element, O is oxygen, n is an integer greater than or equal to 1, and 0≦δ≦0.2.

2. A gas sensor as defined in claim 1, in which n=1.

3. A gas sensor as defined in claim 1, in which the material is tuned by substitution on the A sites.

4. A gas sensor as defined in claim 1, in which the material is tuned by substitution on the B sites.

5. A gas sensor as defined in claim 1, in which A comprises lanthanum, praseodymium, neodymium, or samarium.

6. A gas sensor as defined in claim 3, in which the A site substituent comprises strontium, calcium, or barium.

7. A gas sensor as defined in claim 1, in which B comprises copper, gallium, iron, manganese, cobalt, or nickel.

8. A gas sensor as defined in claim 4, in which the B site substituent comprises magnesium or aluminum.

9. A gas sensor as defined in claim 1, in which the sensor additionally comprises:
a sensor array onto which the Aₙ₊₁BₙO_{(3n+1)±δ} material is applied; and
two or more conductors.

10. A gas sensor as defined in claim 9, in which the sensor array is selected from alumina, zirconia, or any other electrically insulating ceramic substrate.

11. A gas sensor as defined in claim 9, in which the conductors are selected from platinum, gold, silver, or any combination thereof.

12. A gas sensor as claimed in defined in claim 9, in which the Aₙ₊₁BₙO_{(3n+1)±δ} material is applied by screen printing, spraying, or vapor deposition.

13. A gas sensor as defined in claim 9, in which the Aₙ₊₁BₙO_{(3n+1)±δ} material is applied by coating it as a thin layer of the oxide as a suspension and allowing it to dry.

14. A gas sensor as defined in claim 9, in which the conductors are connected to the array by means of spot welding.

15. A gas sensor as defined in claim 1, wherein said gas sensor is arranged and configured to sense one or more of carbon monoxide, ammonia, nitrogen oxides, alcohol, hydrogen sulphide, sulphur dioxide, unburned hydrocarbons, hydrogen, and carbon dioxide.

16. A gas sensor as defined in claim 1, wherein said gas sensor is arranged and configured to detect a gas in a concentration range of 0-2000 ppm.

17. A gas sensor as defined in claim 16, wherein said gas sensor is arranged and configured to detect a gas in a concentration range of 0-1000 ppm.

18. A gas sensor as defined in claim 17, wherein said gas sensor is arranged and configured to detect a gas in a concentration range of 0-200 ppm.

19. A gas sensor as defined in claim 18, wherein said gas sensor is arranged and configured to detect a gas in a concentration range of 0-50 ppm.

20. A gas sensor as defined in claim 19, wherein said gas sensor is arranged and configured to detect a gas in a concentration range of 0-10 ppm.

21. A gas sensor as defined in claim 1, wherein said gas sensor is arranged and configured to detect a gas at a temperature of greater than 300° C.

22. A gas sensor as defined in claim 21, wherein said gas sensor is arranged and configured to detect a gas at a temperature of greater than 350° C.

23. A gas sensor as defined in claim 22, wherein said gas sensor is arranged and configured to detect a gas at a temperature of greater than 400° C.

24. A gas sensor as defined in claim 1, wherein said gas sensor is arranged and configured to detect a gas in an environment with greater than 25% relative humidity.

25. A gas sensor as defined in claim 24, wherein said gas sensor is arranged and configured to detect a gas in an environment with greater than 40% relative humidity.

26. A gas sensor as defined in claim 25, wherein said gas sensor is arranged and configured to detect a gas in an environment with greater than 50% relative humidity.

27. A gas sensor as defined in claim 26, wherein said gas sensor is arranged and configured to detect a gas in an environment with greater than 60% relative humidity.

28. (canceled)

29. A gas sensor, comprising:
an electrically insulating substrate having a surface;
a pair of electrode members disposed in close adjacent relationship to each other on the surface of the electrically insulating substrate;
a sensor material situated on the pair of interdigitated electrodes, the sensor material comprising:
an Aₙ₊₁BₙO_{(3n+1)±δ} type material in which A is an alkaline earth metal or lanthanide, B is a transition element or a group 13 element, O is oxygen, n is an integer greater than or equal to 1, and 0≦δ≦0.2.

30. A gas sensor, comprising:
an electrically insulating substrate having opposite first and second surfaces;
a pair of interdigitated electrodes disposed on the first surface of the electrically insulating substrate;
a microheater disposed on the second surface of the electrically insulating substrate;
a sensor material situated on the pair of interdigitated electrodes, the sensor material comprising:
an Aₙ₊₁BₙO_{(3n+1)±δ} type material in which A is an alkaline earth metal or lanthanide, B is a transition element or a group 13 element, O is oxygen, n is an integer greater than or equal to 1, and 0≦δ≦0.2.

31. A method of making a gas sensor, comprising:
providing an electrically insulating substrate having a surface;
disposing a pair of interdigitated electrodes on the surface of the electrically insulating substrate;
situating a sensor material on the pair of interdigitated electrodes, the sensor material comprising:
an Aₙ₊₁BₙO_{(3n+1)±δ} type material in which A is an alkaline earth metal or lanthanide, B is a transition element or a group 13 element, O is oxygen, n is an integer greater than or equal to 1, and 0≦δ≦0.2.
